(19) United States
(12) Patent Application Publication
(10) Pub. No.: US 2007/0035563 A1
(43) Pub. Date: Feb. 15, 2007

(54) Augmented reality spatial interaction and navigational system

(75) Inventors: Frank Biocca, E. Lansing, MI (US); Charles B. Owens, E. Lansing, MI (US)

Correspondence Address: HARNESS, DICKEY & PIERCE, P.L.C., P.O. BOX 828, BLOOMFIELD HILLS, MI, 48303, US

(73) Assignee: The Board of Trustees of Michigan State University, E. Lansing, MI (US)

(21) Appl. No.: 11/502,964

(22) Filed: Aug. 11, 2006

Related U.S. Application Data
(60) Provisional application No. 60/708,005, filed on Aug. 12, 2005.

(51) Int. Cl. G09G 5/00

(52) U.S. Cl. 345/633

(57) ABSTRACT

A method of operation for use with an augmented reality spatial interaction and navigational system includes receiving initialization information, including a target location corresponding to a point of interest in space, and a source location corresponding to a spatially enabled display. It further includes computing a curve in a screen space of the spatially enabled display between the source location and the target location, and placing a set of patterns along the curve, including illustrating the patterns in the screen space.

### CROSS-REFERENCE TO RELATED APPLICATIONS

This application claims the benefit of U.S. Provisional Application No. 60/708,005, filed on Aug. 12, 2005. The disclosure of the above application is incorporated herein by reference in its entirety for any purpose.

This invention was made with U.S. government support under National Science Foundation Contract No. 0222831. The U.S. government may have certain rights in this invention.

### FIELD OF THE INVENTION

The present invention generally relates to user interfaces for augmented reality and virtual reality applications, and particularly relates to user interface techniques for spatial interaction and navigation.

### BACKGROUND OF THE INVENTION

In mobile Augmented Reality (AR) environments, the volume of information is omnidirectional and can be very large. AR environments can contain large numbers of informational cues about an unlimited number of physical objects or locations. Unlike dynamic WIMP interfaces, AR designers cannot make the assumption that the user is looking in the direction of the object to be cued or even if it is within the vision field at all. These problems persist for several reasons.

A user's ability to detect spatially embedded virtual objects and information in a mobile multitasking setting is very limited. Objects in the environment may be dense, and the system may have information about objects anywhere in an omnidirectional working environment. Even if the user is looking in the correct direction, the object to be cued may be outside the visual field, obscured, or behind the mobile user.

Normal visual attention is limited to the field of view of human eyes (<200°). Visual attention in mobile displays is further limited by decreased resolution and field of view. Unlike architectural environments, the workspace is often not prepared or designed to guide attention. Audio cues have limited utility in mobile environments. Audio can cue the user to perform a search, but the cue provides limited spatial information because audio spatial cueing has limited resolution, the cueing is subject to distortions in current algorithms, and audio cues must compete with environmental noise.

A broad, cross platform interface and interaction design involving mobile users needs to solve five basic HCl challenges in managing and augmenting the capability of mobile users:
Attention management: keeping virtual information from interfering with attention in the physical environment and tasks and actions in that environment.
Object awareness: quickly and successfully cueing visual attention to the locations of the physical or virtual objects or locations.
Spatial information organization: developing a systematic means of organizing, connecting, and presenting spatially-embedded 3D objects and information.
Object selection and manipulation: selecting and manipulating spatially embedded local and distant virtual information objects, menus and environments.
Spatial navigation: presenting navigation information in space.

The present invention fulfills the aforementioned needs.

### SUMMARY OF THE INVENTION

An augmented reality spatial interaction and navigational system includes an initialization module receiving initialization information, including a target location corresponding to a point of interest in space, and a source location corresponding to a spatially enabled display. The initialization module computes a curve in a screen space of the spatially enabled display between the source location and the target location. A pattern presentation module places a set of patterns along the curve by illustrating the patterns in the screen space.

The augmented reality spatial interaction and navigation system according to the present invention is advantageous over previous augmented reality user interface techniques in several ways. For example, the funnel is more effective at intuitively drawing user attention to points of interest in 3D space than previous AR techniques. Accordingly, the funnel can be used to draw attention of the user to an object in space, including specifying a location of the object as the target location. Also, the funnel can be used to provide navigational instructions to the user by causing the curve to lie upon a known route in space, such as a roadway. Multiple curves can be employed as a compound curve that leads the user to an egress point that continuously changes as the user moves. Further, the funnel can be used as a selection tool that allows the user to select a spatial point by moving the display to train the funnel on the point, and this selection functionality can be expanded in various ways.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a set of perspective views, including FIGS. 1A-C, illustrating patterns rendered to a user of an augmented reality spatial interaction and navigational system in accordance with the present invention;

FIG. 2 is a block diagram illustrating an augmented reality spatial interaction and navigational system in accordance with the present invention; and

FIG. 3 is a flow diagram illustrating a method of operation for an augmented reality spatial interaction and navigational system in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

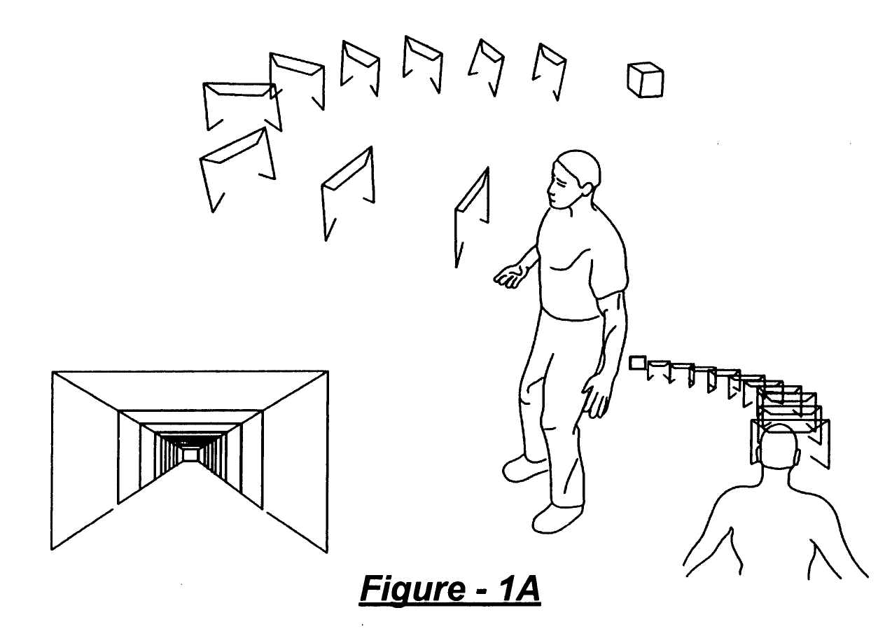

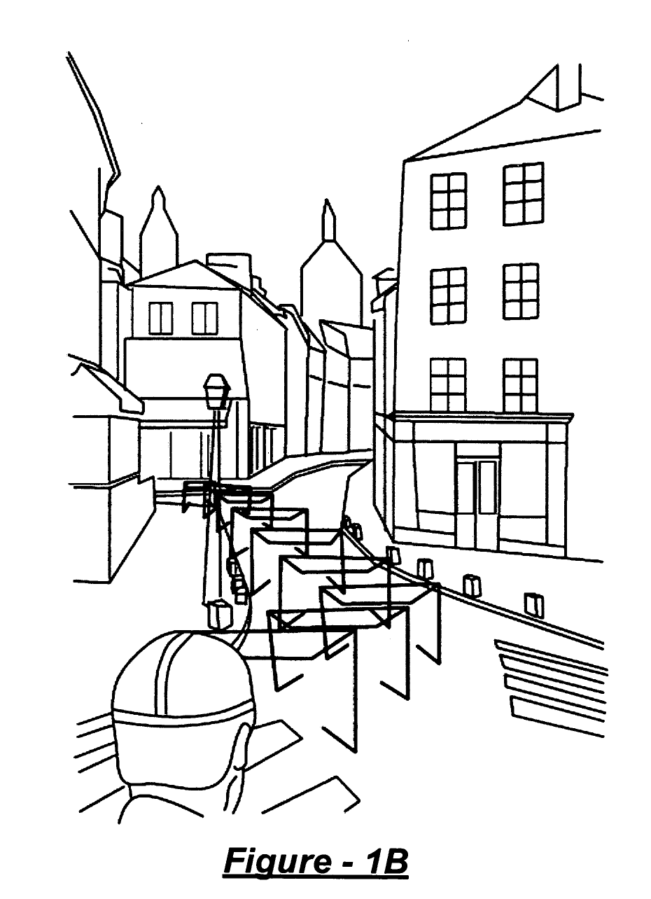

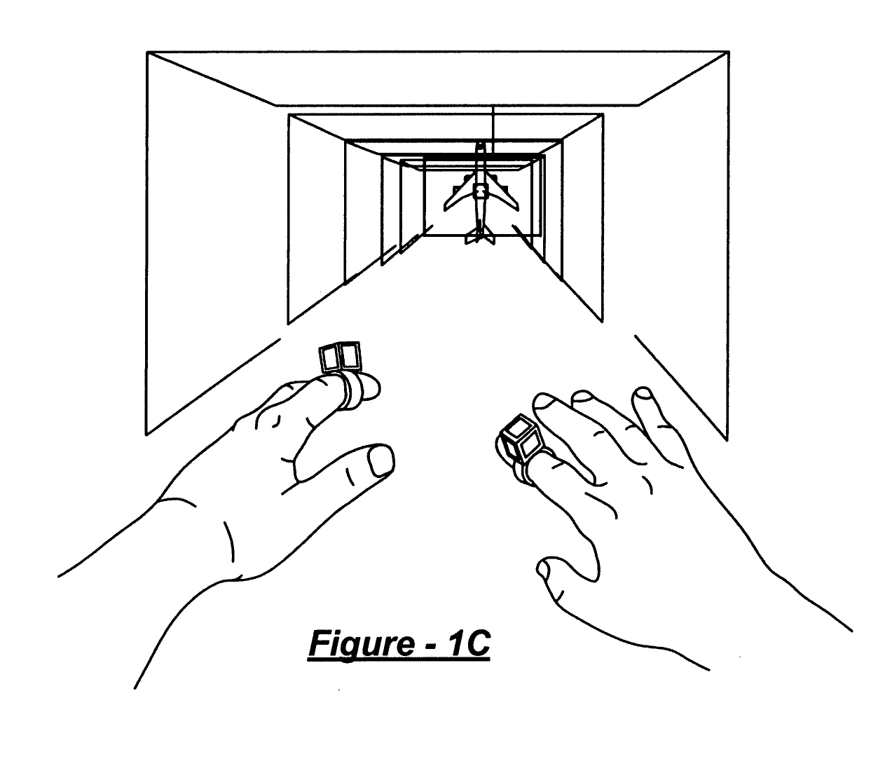

Starting with FIG. 1 and referring generally to FIGS. 1A-C, in some embodiments, the augmented reality navigational system according to the present invention produces an omnidirectional interaction funnel as a cross-platform paradigm for physical and virtual object interaction in mobile cell, PDA, vehicle heads up display, and immersive augmented reality. The interaction funnel paradigm includes: (1) a family of interaction and display techniques combined with (2) methods for tracking users, and (3) detecting the location of objects to be cued.

Spatial interaction funnels (see FIG. 1A) can go in any direction for directing attention to objects immediately around the user (i.e., any object in a room, etc.). A variant, a navigation funnel (see FIG. 1B), can be similar. However, it is envisioned that the navigational funnel can be placed above the head of the user and used to direct attention and motion to objects-locations-people outside the immediate space (e.g., a restaurant down the street, a landmark, another room, a team member far away, etc.). Additional types of interaction funnels according to the present invention include the attention funnel and selection funnel (see FIG. 1C) described further below.

In essence, the interaction funnel, such as a spatial interaction funnel or navigational funnel, is a general purpose 3D paradigm to direct attention, vision, or personal navigation to any location-object-person in space. Given the appropriate tracking (i.e., GPS or other location in space and orientation of the sensor-display), it can be implemented on any mobile platform, from a cell phone to an immersive, head worn, augmented reality system. It is envisioned that the implementation involving head-worn visual displays can be the most compelling and intuitive implementation.

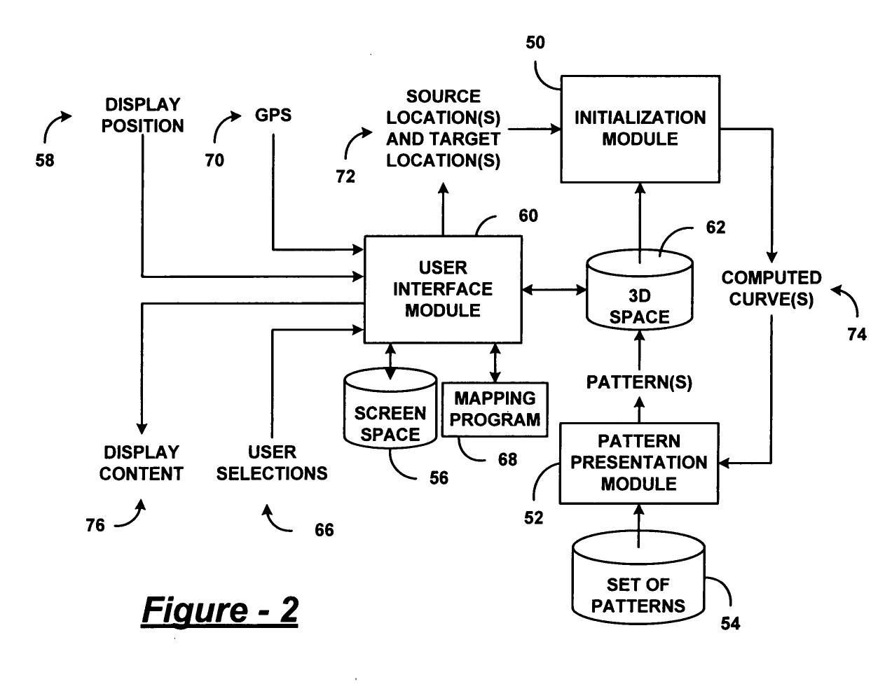

Turning now to FIG. 2, the augmented reality spatial interaction and navigational system has an initialization module 50 and a pattern presentation module 52 provided with a set of patterns 54. In a manner known in the art, a user screen space 56 is computed as a function of user display position 58 by an augmented reality user interface module 60 having tracking capabilities. One skilled in the art will readily appreciate that the screen space 56 is a virtual viewpoint of a virtual 3D space 62 to be overlaid upon an actual user viewpoint of actual space. Generally, virtual objects or locations in the 3D space 62 correspond to actual objects or locations in actual space. One such object is the position 58 of the user or user display, with position and orientation of the user display in actual space being tracked in a known manner in order to determine the screen space 56. This position 58 is used as a source location, and another object or location indicated, for example, by user selections 66 or a mapping program 68, with GPS input 70, can be used to determine a target location. Interim source/target locations can be provided as waypoints in a route or computed to navigate around known obstacles in the screen space. Thus, one or more source and target locations 72 are provided to the initialization module 50.

In some embodiments, the initialization module 50 computes one or more curves in the 3D space 62 between the source and target locations 72, and communicates these curves 74 to presentation module 52. In the case of multiple locations including interim locations, as in route waypoints for navigation, a set of connected curves can be computed to navigate those waypoints. Thus, one or more curves 74 are provided to presentation module 52. Presentation module 52 then places patterns of the set 54 on the curve or curves in the 3D space 62, causing some or all of them to be rendered in the screen space 56. In some embodiments, the patterns of the set are varied in appearance to draw perspective attention to a depth and center of a funnel formed by the set of patterns. A fading effect can be employed for a pattern that extends far into the distance (e.g., a navigation route). User interface module continuously displays contents 76 of the screen space 56 to the user. Therefore, the user sees the patterns presented by presentation module 52, and experiences the presentation of the patterns changing in real time based on user movement of the display.

In some embodiments, user selections 66 can be made as a function of user movement of the display position 58 in order to train the presented patterns on objects or locations in actual or virtual space. This functionality can, for example, assist the user in accurately selecting a viewable point in actual space to associate with an object or location in virtual space. For example, the user of a head mounted display, cell phone, etc. can designate a predefined target location (e.g., distant point in a center of the screen space at the time of the designation), adjust the screen position to train the pattern on an object in actual space, and make a selection to indicate that the object's location in virtual space lies on this first curve. Then the user can designate a new target location in another point in space, adjust the screen position to train the pattern on the object in actual space, and make another selection to indicate that the object's location in virtual space lies on this second curve. Then, the object's location in virtual space can be set as a point corresponding to the intersection of the two curves. As a result, the user can quickly and easily indicate a distant object's location without having to travel to the object or performing a time consuming, attention consuming, and potentially error prone task of manipulating a cursor into position three-dimensionally.

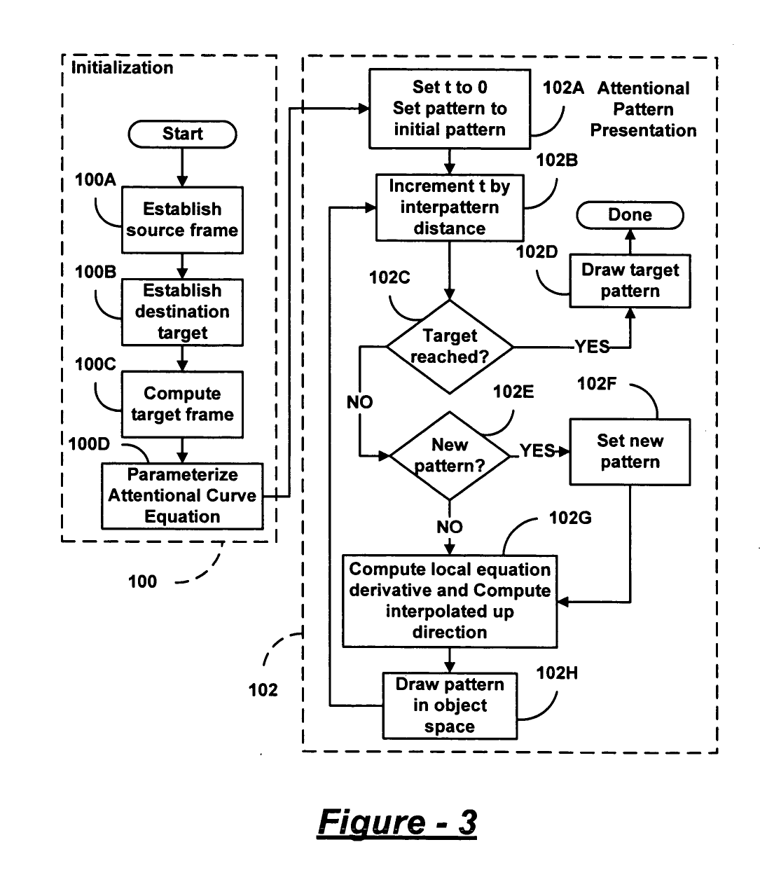

Turning now to FIG. 3, the method according to the present invention can be represented as an initialization stage 100 and a pattern presentation stage 102. The driving mathematical element is a parameterized curve. In some embodiments, a Hermite curve, a cubic curve that is specified by a derivative vector on each end, is used. In some embodiments the curve can consist of multiple cubic curve segments, where each segment represents a path between waypoints. The curve may be specified by derivative vectors on the ends, as in the Hermite embodiment, points along the curve, as in Bezier or Spline curve methodologies. The overall method involves establishing a source frame (where the curve starts and the pattern orientation at that location) and a target frame (where the curve ends and a pattern orientation at that end). In some embodiments, the method involves specification of waypoints that the curve must pass through or near. It also involves computing the parameters for the curve (often called coefficients), and then iterating over the pattern presentation.

Some embodiments allow multiple patterns to be set. A pattern is what a user sees along the path of the funnel that is produced. Commonly, the first pattern is different and there is a final pattern. The actual implementation can be rather general, allowing patterns to be changed along the path. For example, one might use one pattern for the first 10 meters, and then change to another as a visual cue of distance to the target. Each pattern is specified with a starting distance (where this pattern begins as a distance from the starting point) and a repetition spacing. A typical specification might consist of a start pattern at distance 0 with no repetition, then another pattern starting at 15 cm and repeating every 15 cm. When the curve reaches a distance equal to the start of a new pattern, the new pattern is selected. Patterns are sorted in order of starting distance.

A presently preferred embodiment derives the curve by using a Hermite curve. The Hermite curve is a common method in computer graphics for defining a curve from one point to another. There is little control of the curve in the interim distance, which works very well in near-field implementations. A single curve can be translated to a compound curve consisting of many cubic curve segments. This compound curve can be thought of as multiple Hermite curves attached end-to-end. Additional or alternative embodiments can use Spline curves (which have a similar implementation but are specified differently). In general, however, the particular type of curve employed to achieve the smooth curve presentation of the patterns is not important, as many techniques are suitable.

As input, the method can use data from a mapping system (e.g., MapPoint available from Microsoft®) to provide a path. The path thus provided can then be converted into control points to specify a curved path, as this curvature is the natural presentation for the funnel. Accordingly, the funnel of patterns drawn along the curve can follow a known route in real space that the curve is based on, such as a roadway as illustrated in FIG. 1B.

Returning to FIG. 3, the initialization phase 100 collects the input specifications for the system and prepares the internal structures for pattern presentation. The input for the system can include various items. For example, it can include a starting frame specification, which is a location and orientation in 3D space. Typically this specification is related to the viewing platform. For a monoscopic display, the origin can be typically set some fixed distance from the center of the display in the viewing direction. The Z axis can be oriented in the viewing direction, and the X and Y axis oriented horizontally and vertically on the display. For stereoscopic displays the origin can be offset from a point centered between the two display centers.

Another input for the system can be destination target, which is a 3D point in real space. An additional input for the system can be a set of pattern specifications, which provide a pattern in the actual shape that will be displayed along the funnel. A set of these patterns are provided, so that the pattern can change along the funnel. This use of a set of patterns allows, for example, a unique pattern as the starting (first pattern) and varying patterns along the funnel as an attentional queue. Each pattern can have an associated starting distance and repetition distance, which can be determined as a function of the distance to the target. For example, imagine an invisible line from the start frame to the target that traces the path of the funnel. The starting distance is how far along this line a given pattern will become active and be displayed for the first time. The repetition distance is how often after first display a pattern is repeated. These are actual distances. Another input to the system can be a target pattern specification. For example, a target pattern can specified that will be drawn at the target location so as to provide an end point of the funnel and final targeting.

In some embodiments, the initialization stage 100 can proceed by first establishing a source frame at step 100A. Accordingly, the starting frame can be directly specified as input, so all that may be necessary is coding it in an appropriate internal format. Then, the destination target can be established at step 100B, for example, as a specified input. Next, the target frame can be computed at step 100C, for example, as a specification in space of position and orientation.

In some embodiments, the target can be specified as a 3D point, and from that point a target frame can be computed. The Z direction of this frame can be specified as pointed at the source frame origin. This specification follows a concept in computer graphics called billboarding. The up direction can be determined by orienting the frame so the world Y axis is in the YZ plane of the target frame. Additional details are provided below for a discussion of a variation using waypoint frames.

Finally, the initialization phase can conclude with parameterization of the curve equation at step 100D. The curve equation can be a 3D equation of the form: <x, y, z>=f(t). The value of t can range from 0 to 1 over the range of the curve and can be a parameterize curve control value. The equation can require the computation of appropriate parameters such as cubic equation coefficients. This computation can be viewed as a translation of the input specification into the numeric values necessary to actually implement the curve. Parameters for the derivative of the curve can also be computed.

The pattern presentation stage 102 follows the initialization stage. At step 102A, t is set to zero and a current pattern variable is set to be the initial pattern of the provided pattern set. This step 102A simply prepares for the presentation loop. Next, t is incremented by the interpattern distance at step 102B. The variable t is a control value for the curve. It needs to be incremented so as to move a distance down the curve necessary to reach the next presentation location. For the first pattern, this distance is often zero. For other patterns this will be the distance to the first draw location of the next pattern or the repeat location of the current pattern, whichever is least. The local derivative of the curve equation can be used to determine step distances and the value of t can be increased incrementally.

At step 102C, a determination is made regarding whether the target is reached. A stopping point can be indicated by a t value greater than or equal to 1. At this point, the target pattern is drawn in the target frame at step 102D and the process is complete.

At step 102E, a determination is made whether it is necessary to switch to a new pattern, such as the next pattern in the set. A new pattern can be indicated by the pattern starting distance for that pattern being reached. At that point, the previous pattern can be discarded and replaced with the new pattern at step 102F.

At step 102G, the local equation derivative and interpolated up direction are computed. In order to draw a pattern, a frame can be specified so that the pattern is placed and oriented correctly. The origin of the frame can simply be the computed curve location. The Z axis can be oriented parallel to the derivative of the curve location at the current local point. The up direction can be computed by spherical linear interpolation of the up direction of the source and target frames. From this information a local frame can be computed (object space) and the pattern drawn at step 102H.

Some embodiments can use a single cubic curve segment to specify the pattern presentation. Alternative or additional embodiments can use GIS data from a commercial map program (Mappoint) to provide a more complex path along roadways and such. Such embodiments can use intermediate points (waypoints) along the curve. Each point can have an associated computed frame. The spaces between can then be implemented using Hermite curves. Alternative or additional embodiments can use the waypoints as specifications for a Spline curve. Each of these implementations can have in command a smooth funnel presentation from source to target, though the undulations of the curve may vary. The “best” choice may be entirely aesthetic.

The spatial interaction funnel is an embodied interaction paradigm guided by research on perception and action systems. Embodied interaction paradigms seek to leverage and augment body-centered coupling between perceptual, proprioceptive, and motor action to guide interaction with virtual objects. FIG. 1B illustrates the general interaction funnel AR display technique for rapidly guiding visual attention to any location in physical or virtual space. The most visible component is the set of dynamic, linked, 3D virtual planes directly connecting the view of the mobile user to the distant virtual or physical object.

From a 3D point of view, the interaction funnel visually and dynamically connects two 3D information spaces (frames): an eye-centered space based on the user's view, either through a head-mounted display or through a PDA or cell phone and an object coordinate space. When used as an attention funnel (see below) the connection cues and funnels focus spatial attention of the user quickly to the cued object.

The spatial interaction funnel paradigm leverages several aspects of human perception and cognition: funnels provide bottom up visual cues for locating attention; and they intuitively cue how the body should move relative to an object; they draw upon users' intuitive experience with dynamic links to objects (e.g., rope, string).

Referring now to FIG. 1A, the basic components in an omnidirectional interaction funnel are: (a) a view plane pattern with a virtual boresight or target in the center, (b) a set of funnel planes, designed with perspective cues to draw perspective attention to the depth and center; and (c) a linking spline from the head or viewpoint of the user to the object. Attention is visually directed to a target in a natural and fluid way that provides directions in 3D space. The link can be followed rapidly and efficiently to an attention target irregardless of the current position of the target relative to the user or the distance to the target.

Turning now to FIG. 1A, the attention funnel planes appear as a virtual tunnel. The patterns clearly indicate direction to the target and target orientation relative to the user. The vertical orientation (roll) of each pattern along the visual path is obtained by the spherical linear interpolation of the up direction of the source frame and the up direction of the target frame. The azimuth and elevation of the pattern are determined by the local differential of the linking spline. The view plane pattern is a final indication of target location.

The intuitive omnidirectional funnel link to virtual objects is used to derive classes of designs to perform specific user functions: the attention funnel, navigation funnel, and selection funnel.

An attention funnel links the viewpoint of a mobile user directly to a cued object. Unlike traditional AR and existing mobile systems, the cued object can be anywhere in near or distant space around the user. Cues can be activated by the system (systems alerts, or guides to “look at this location, now”) or by a remote user activating a tag (i.e., “take a look at that item.”) Preliminary testing indicates that the attention funnel technique can improve object search time by 24%, and object retrieval time by 18%, and decrease erroneous search paths by 100%.

It is envisioned that the funnel can be extended to much larger environments and be used for both attention and navigation directions. These extensions entail several new design elements. For example, the linking spline can be a curve that directs attention to the target, even when the target is at a considerable distance or obscured. In addition to attention direction that can be realized by moving the head, in distant environments, a mobile user may potentially traverse the path to the object. Hence, the linking spline can be built from multiple curve segments influenced by GPS navigation information. The roll computation can be designed according to segments positively orienting the user in the initial and final traversal phases.

Pattern placement on the linking spline is a visual optimization problem. Patterns can be placed at fixed distances along the spline with the distance selected visually. Use of this same structure for distances beyond the very near field (less than two meters) results in considerable clutter. Hence, some embodiments can place the patterns at distances that appear equally spaced in the presence of foreshortening and balance effectiveness with visual clutter.

Turning now to FIG. 1C, the selection funnel can be modeled on human focal spatial cognition to implement a paradigm to select distant objects (objects in near space can be directly manipulated using hand tracking). The problem with selection of distant objects is the determination of distance. Human pointing, be it with the head or hands, provides only a ray in space which can be inaccurate and unstable at longer distances. One can point at something, but the distance to the object is not always clear. Two scenarios occur: an object with known depth and geometry is selected or an object that is completely unknown is selected.

A head-centered selection funnel (see FIG. 1B) leverages the human ability to track objects with eye and hand movements, allowing individuals to select a distant object such as a building, location, person, etc. for which 3D information in the form of actual geometry information or bounding boxes is known. Selection can be accomplished by pointing the selection funnel using the head and indicating the selection operation, either using finger motions or voice. Head pointing is relatively difficult for users due to the limited precision of neck muscles, so the flexible nature of the linking spline will be used to dampen the motion of the selection funnel so it is easier to point. The perceptual effect is that of a long rubber stick attached to the head. The stick has mass, so it does not move instantly with head motion, but rather exhibits a natural flexibility.

Once selected, a virtual object can be subject to manipulation. The selection funnel can also serve as a manipulation tool. Depth modification (the distance of the object) will require an additional degree of freedom of input. This modification can be accomplished using proximity of two fiducials on the fingers or between two hands. More complex, two-handed gestural interfaces can allow for distant manipulation such as translation, rotation, and sizing by “pushing” “pulling” “rotating” and “twisting” the funnel until the object is located in its new location, much as strings on a kite might control the location and movement of the distant kite. One of the goals of this design process is to avoid modality, making possible the simultaneous manipulation of depth and orientation while selected.

The selection of objects or points in space for which no depth or geometry information is known is also of great use, particularly in a collaborative environment where one user may need to indicate a building or sign to another. Barring vision-based object segmentation and modeling, the depth must be specified directly by the user. The selection funnel provides a ray in space.

Moving to another location, potentially even a small distance away, provides another ray. The nearest point to the intersection of these two rays indicates a point in space. Of course, the accuracy of the depth information is dependent on the accuracy of the selection process, a parameter that will be measured in user studies. But, the selected point in space is clearly indicated by the attention funnel, which provides not only a target indicator at the correct depth (indicated both by stereopsis and motion parallax), but also provides depth cues due to the foreshortening of the attention funnel patterns and the curvature of the linking spline.

The navigation funnel leverages research on the use of landmarks and dead reckoning to develop a cross-platform interaction technique to guide mobile, walking users (see FIG. 1B). The interaction funnel links users to a dynamic path via a 3D navigation funnel. The navigation translates GPS navigation techniques to the 3D physical environment. Landmarks (i.e., Eiffel Tower, home) are made continuously visible by embedding a 3D sky tag indicating the relative location of the landmark to the current user location and orientation.

A major issue is the management of visual clutter in the active peripersonal space, the visual space directly in front of the user. Attention patterns presented to mobile users must be designed and placed so as to avoid occlusions that could mask hazards. A semitransparent funnel will be less visually distracting. It has also been predicted by our research that the funnel can be effective even if it is faded when the attention/traversal path is valid. The scenario for a mobile user would have the funnel appear only when necessary to enforce direction, either due to deviation or upcoming direction change.

Additional or alternative embodiments can make use of overhead mirroring of the attention funnel. The idea is to present a virtual overhead viewplane that mirrors the funnel's linking spline in space. This viewplane provides several unique user interface opportunities. The overhead image can present map material as provided by the GPS navigation system, including the presentation of known 3D physical landmarks and their placement relative to the user. This allows the user to know current relative placement. This mirroring can allow the attention funnel to fade while still presenting path information. Because the effect is a mirroring of the funnel (more precisely a non-linear projection), the two mechanisms will be clearly correlated and support each other.

Neurocognitive studies of the visual field indicate that the upper visual field is linked to the perception of far space. This suggests that users may be able to make use of “sky maps.” Potential placements for such a map include a circular waist level map for destination selection, and a “floor map” for general orientation. It is envisioned that a mirroring plane can utilize varying scale, allowing greater resolution for nearer landmarks and decreased resolution to present distances efficiently.

The present invention can also address issues relating to information interaction in egocentric near space (peripersonal). For example, in a mobile AR environment, information can be linked to locations in space. The user constitutes a key set of 3D mobile information spaces. Several classes of information are “person centric” and not related to spatial environmental location such as user tools, calendar data, and generic information files, etc. Such information is commonly “carried” within mobile devices such as cell phones and PDAs. In mobile AR systems, this information can be more efficiently recalled by being attached (tagged) to egocentric, body centered frames. In our mobile infospaces systems, we have used several body centered frames including head-centered, limb-based, hands, arms and torso. A significant amount of human spatial cognition appears focused on the processing of objects in near space around the body. Users can adapt very quickly to large volumes of information arrayed and “attached” to the body in egocentric information space. Accordingly, the present invention can multiply the ways in which users can interact with information frames in near and far space, connecting both in everyday annotation and information retrieval.

For details relating to the technological arts with respect to which the present invention has been developed, reference may be taken various texts. For example, some details regarding head worn apparatuses that can be employed with the present invention can be found in Biocca et al. (U.S. Pat. No. 6,774,869), entitled Teleportal Face to Face System. Also, the general concept of an augmented display, both handheld and HMD, is additionally disclosed in Fateh et al. (U.S. Pat. No. 6,184,847), entitled Intuitive Control of Portable Data Displays. Further, the details of some head-mounted displays are disclosed in Tabata et al. (U.S. Pat. No. 5,579,026), entitled Image Display Apparatus of Head Mounted Type. Each of the aforementioned issued U.S. patents is incorporated herein by reference in its entirety for any purpose. Still further, details regarding sync patterns can be found in Hochberg, J., Representation of motion and space in video and cinematic displays, in Handbook of Perception and Human Performance, K. R. Boff, L. Kaufmann, and J. P. Thomas, Editors, 1986, Wiley: New York. pp. 22/1-22/64. Yet further, a computer graphics text containing standard curve content is Hearn, D. and Baker, M. P., Computer Graphics, C Version, 2nd Edition, Prentice Hall, (1996). Further still, spherical interpolation was introduced in Shoemake, K., Animating Rotation with Quaternion Curves, in Proceedings of the 12th Annual Conference on Computer Graphics and Interactive Techniques, (1985). The teachings of the aforementioned publications are also incorporated by reference in their entirety for any purpose.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An augmented reality spatial interaction and navigational system, comprising:
an initialization module receiving initialization information, including a target location corresponding to a point of interest in space, and a source location corresponding to a spatially enabled display, and computing a curve in a screen space of the spatially enabled display between the source location and the target location; and
a pattern presentation module placing a set of patterns along the curve, including illustrating the patterns in the screen space.

2. The system of claim 1, wherein the patterns at least include planes with a virtual bore-sight in the center.

3. The system of claim 2, wherein placement of the patterns accomplishes orientation of the planes normal to the curve at points of placement of the planes.

4. The system of claim 1, wherein the patterns of the set-are varied in appearance to draw perspective attention to a depth and center of a funnel formed by the set of patterns.

5. The system of claim 1, further comprising a curve refreshing module refreshing the curve during movement of one or more of the source location and the target location.

6. The system of claim 1, further comprising a user interface employing the funnel as a user interface component.

7. The system of claim 6, wherein said user interface employs the funnel to draw attention of the user to an object in space.

8. The system of claim 7, wherein said user interface specifies a location of the object as the target location.

9. The system of claim 6, wherein said user interface employs the funnel to provide navigational instructions to the user.

10. The system of claim 9, wherein said user interface causes the curve to lie upon a known route in space.

11. The system of claim 6, wherein said user interface module employs the funnel to allow the user to select a spatial point.

12. The system of claim 11, wherein said user interface module detects training the funnel on the point produced by user movement of the display.

13. The system of claim 1, wherein said pattern presentation module initializes a current pattern variable to be an initial pattern of the set of patterns.

14. The system of claim 13, wherein said pattern presentation module initializes a control value for the curve by an interpattern distance in order to move a distance down the curve necessary to reach a next presentation location.

15. The system of claim 14, wherein said pattern presentation module uses a local derivative of the curve to determine step distances for increasing the control value incrementally.

16. The system of claim 1, wherein said pattern presentation module determines whether the target is reached and completes the curve when the target is reached by placing a final pattern of the set.

17. The system of claim 1, wherein said pattern presentation module determines whether a pattern starting distance has been reached for a next pattern in the set.

18. The system of claim 17, wherein said pattern presentation module resets the current pattern variable to the next pattern in the set when the pattern starting distance is reached.

19. The system of claim 1, wherein said pattern presentation module computes a local equation derivative and interpolated up direction for a local frame having an origin at a computed curve location, and uses the frame to draw the pattern.

20. A method of operation for use with an augmented reality spatial interaction and navigational system, comprising:
receiving initialization information, including a target location corresponding to a point of interest in space, and a source location corresponding to a spatially enabled display;
computing a curve in a screen space of the spatially enabled display between the source location and the target location;
placing a set of patterns along the curve, including illustrating the patterns in the screen space.

21. The method of claim 20, wherein the patterns at least include planes with a virtual bore-sight in the center.

22. The method of claim 21, wherein placement of the patterns accomplishes orientation of the planes normal to the curve at points of placement of the planes.

23. The method of claim 20, wherein the patterns of the set are varied in appearance to draw perspective attention to a depth and center of a funnel formed by the set of patterns.

24. The method of claim 20, further comprising refreshing the curve during movement of one or more of the source location and the target location.

25. The method of claim 20, further comprising employing the funnel as a user interface component.

26. The method of claim 25, further comprising employing the funnel to draw attention of the user to an object in space.

27. The method of claim 26, further comprising specifying a location of the object as the target location.

28. The method of claim 25, further comprising employing the funnel to provide navigational instructions to the user.

29. The method of claim 28, further comprising causing the curve to lie upon a known route in space.

30. The method of claim 25, further comprising employing the funnel to allow the user to select a spatial point.

31. The method of claim 30, further comprising detecting training the funnel on the point produced by user movement of the display.

32. The method of claim 20, further comprising initializing a current pattern variable to be an initial pattern of the set of patterns.

33. The method of claim 32, further comprising incrementing a control value for the curve by an interpattern distance in order to move a distance down the curve necessary to reach a next presentation location.

34. The method of claim 33, further comprising using a local derivative of the curve to determine step distances for increasing the control value incrementally.

35. The method of claim 20, further comprising determining whether the target is reached and completing the curve when the target is reached by placing a final pattern of the set.

36. The method of claim 20, further comprising determining whether a pattern starting distance has been reached for a next pattern in the set.

37. The method of claim 36, further comprising resetting the current pattern variable to the next pattern in the set when the pattern starting distance is reached.

38. The method of claim 20, further comprising computing a local equation derivative and interpolated up direction for a local frame having an origin at a computed curve location, and using the frame to draw the pattern.
